(19) United States
(12) Patent Application Publication
(10) Pub. No.: US 2020/0383316 A1
(43) Pub. Date: Dec. 10, 2020

(54) WATERPROOF ELECTRONIC DECOY TECHNOLOGY

(71) Applicant: Tim Noe, Hudson, WI (US)

(72) Inventor: Tim Noe, Hudson, WI (US)

(21) Appl. No.: 16/749,699

(22) Filed: Jan. 22, 2020

Related U.S. Application Data
(63) Continuation of application No. 62/795,285, filed on Jan. 22, 2019.

(51) Int. Cl. A01M 31/06

(52) U.S. Cl. CPC A01M 31/06

(57) ABSTRACT

A waterproof moving wing waterfowl or migratory bird decoy including a decoy body constructed of a waterproof, polymeric with exterior ornamentation to simulate a live waterfowl or migratory bird, the decoy body being arranged in a predetermined orientation to simulate a waterfowl or migratory bird, the decoy body having a top and a bottom. The decoy has at least one decoy wing connected to the decoy body, the decoy wing being constructed and arranged to simulate the wing of a waterfowl or migratory bird. The decoy has a power and control module, the power and control module being connectible and dis-connectible to the decoy body at the bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity.

### CROSS-REFERENCE TO RELATED APPLICATIONS, IF ANY

This application claims the benefit under 35 U.S.C. § 119(e) of co-pending U.S. Provisional Patent Application Ser. No. 62/795,285, filed Jan. 22,2019, which is hereby incorporated by reference.

### 37 C.F.R. § 1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

### 1. Field of the Invention

The present invention relates, generally, to hunting systems, apparatus and methods. More particularly, the invention relates to a decoy apparatus and method. Most particularly, the invention relates to a spinning or flapping wing decoy that is constructed and arranged to realistically resemble a waterfowl or other migrating bird, such as a duck, that has a removable control and power module which is disposed on the bottom of the decoy, which is plug and play electronic controllable, which is mountable on a post via a female type receptacle, and which has a biased stabilizer that also mimics the legs of the duck.

### 2. Background Information

Decoys have been used for centuries to imitate an animal such as a bird for the purpose of attracting other birds or animals to a particular location for hunting or other purposes. Modern waterfowl decoys come in many types, including floating, ground placed, and stake or base mounted. Decoy bodies may have fixed wings or movable wings. Movable wings may be spinning, flapping or the like. And movable wings may be actuated by motor power, by wind, or by other forces. Many waterfowl decoys are constructed of inexpensive plastic materials.

Existing decoys are believed to have significant limitations and shortcomings. One problem for motorized moving wing decoys is that the power and motor mechanisms disposed inside decoy bodies are accessed through a cover or door placed on the top of the decoy body. This exposes the power and motor mechanisms to moisture from rain, other precipitation, wave action, and the like, and to dust and dirt in the environment. Another problem with top mounted access panels is that they present break lines that degrade the quality of the imitation body features of the decoy species. This is particularly a problem for bodies constructed of commonly used plastics. Commonly used plastics, although inexpensive to use, limit the quality of imitation ornamentation. Other problems exist with respect to mounting of decoys on stakes or other bases, and to inferior control mechanisms and features, particularly remote control features.

Applicant's U.S. Patent Application Publication US 2017/0332620 entitled Decoy Technology, published Nov. 23,2017, discloses a highly water resistant decoy which solves many of the problems of the prior art. Applicant's present invention advances the technology of waterproofing to a superior level.

For these and other reasons, a need exists for the present invention.

All U.S. patents and patent applications, and all other published documents mentioned anywhere in this application are incorporated by reference in their entirety.

### BRIEF SUMMARY OF THE INVENTION

The present invention provides a waterfowl or migratory bird decoy for hunting purposes, and methods of manufacture and use therefore, which are practical, effective, reliable, and efficient, and which are believed to fulfill a need and to constitute an improvement over the background technology.

In one aspect, the invention provides a waterproof decoy comprising,

a decoy body constructed of a polymeric material, the decoy body having a top, a bottom and sides:
at least one decoy wing connected to the decoy body at one or more sides of the decoy body;
a power and control module, the power and control module being connectible and dis-connectible to the decoy body at the bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity.

In another aspect, the invention provides a waterproof decoy comprising,

A a decoy body constructed of a polymeric material the decoy body having a top, a bottom and sides;
B at least one decoy wing connected to the decoy body at one or more sides of the decoy body;
C a motor assembly disposed in an interior cavity of the decoy body, the motor assembly being communicatively connected to the power and control module and couplable to the at least one decoy wing;
D a base member connected to the decoy body at the bottom of the decoy body, the waterproof housing being manually and readily connectible and dis-connectible from the base member without the use of tools; and
E a power and control module, the power and control module being connectible and dis-connectible to the decoy body at rite bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity, wherein:
i the electronic control assembly comprises an on/off switch communicatively connected to an electronic control circuit, a battery recharge port communicatively connected to the electronic control circuit, and a plug and play software module, connectible and dis-connectible from the control circuit, which provides remote control capability;
ii the base member a shell member connected to the decoy body, the shell member having an aperture through which the power and control module is insertable and removable; and
iii power and control module housing has at least one base connector and the base member housing has at least one complementary module connector for readily connecting and disconnecting the power and control module to and from the base member, via the aperture in the shell member.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

The present invention, and the manner and process of making and using it, will be belter understood by those skilled in the art by reference to the following drawings.

FIG. 1 is side, elevation view of an embodiment of the decoy of the present invention. The opposite side is substantially a mirror image thereof.

FIG. 2 is a top view of the decoy.

FIG. 3 is a bottom view of the decoy.

FIG. 4 is a detailed view of the bottom of the decoy, showing a base member fastened to the body of the decoy, and a an removable, water-proof power and control module inserted there into.

FIG. 5 shows the removable, waterproof module (in perspective) disconnected therefrom.

FIG. 6 shows the bottom of the decoy body with the base member removed from the body to show the base member cavity, the interior of the body, and a motor assembly connected to the interior of the body.

FIG. 7 is a perspective view of the removable, waterproof, control and power module.

FIG. 8 shows the waterproof door of the module in an open state, exposing the internal cavity, removable control card, and battery slot thereof.

FIG. 9 is a detailed view of the open module.

FIG. 10 shows an embodiment of the control card being removed from the module.

FIG. 11 is a perspective view of the preferred embodiment of the base member.

FIG. 12 is a perspective view of an embodiment of the remote control handset of the decoy.

FIG. 13 is an exploded view of the base member and module assembly removed from the decoy body.

FIG. 14a is a view of exterior of the base and module assembly, oriented as it would be when disposed in the bottom of the decoy.

FIG. 14b is a view of the top (interior view) of the base and module assembly.

FIG. 14c and 14d are side elevation views of the base and module assembly.

FIG. 14e and 14f are end elevation views of the base and module assemblies.

FIG. 15a is a view of the exterior side (bottom) of the base or insert assembly.

FIG. 15b is a view of the interior side (top) of the base assembly.

FIG. 15c-f are elevation views of the base assembly.

FIG. 16a is a view of the exterior (bottom) of a preferred embodiment of the waterproof module housing or box.

FIG. 16b is a view of the interior (top) of the module housing.

FIGS. 6c-f are elevation views of the module housing.

FIGS. 17a-f are views of the subassembly components of the module (operatively coupled) which are disposed inside the module housing.

FIG. 18a-f are views of an embodiment of a battery holder of the module subassembly.

FIG. 19a-f are views of an embodiment of an electronic control circuit PCB of the subassembly.

FIGS. 20a-f are views of an embodiment of a battery of the module subassembly.

FIGS. 21a-f are views of an embodiment of a removable USB software module of the subassembly.

### DETAILED DESCRIPTION

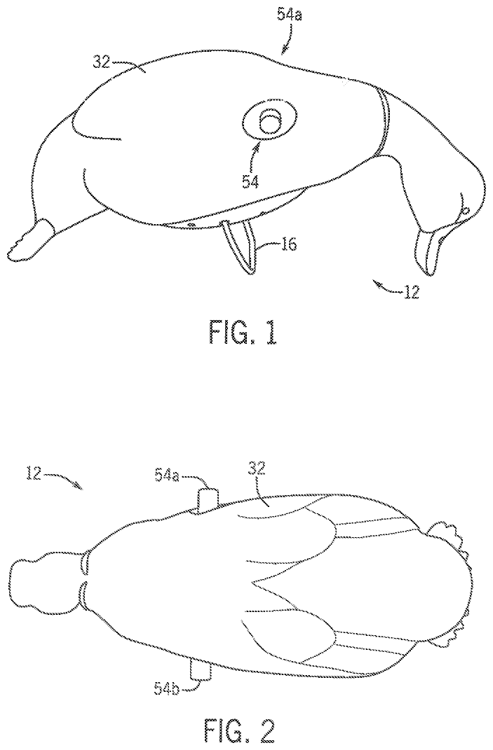

Referring to FIGS. 1 and 2, one embodiment of the decoy set 10 of the invention includes a waterproof decoy 12 and a mounting base 14. The decoy 12 embodiment simulates a waterfowl or migratory bird, particularly in this embodiment, a duck (most particularly a mallard). The decoy 12 is coupled to the base 14 by a friction fit type, insert connection (female type in the decoy 12 and male type for the base 14) between the top of the base 14 and the bottom of the decoy 12. Preferably, the set 10 includes a stabilizer 16, most preferably a biased stabilizer cord. The embodiment of the base 14 is a post or stake which has a vertical member 18 with a top 20 and a bottom 22 and a horizontal member 24 that forms a T type configuration. The bottom end 22 may be configured as a spike to pierce the earth, for example the submerged bottom of a lake, pond, marsh or the like. The T type configuration forms a handle at the top of the base 24 to facilitate easier manual pushing during placement and pulling during removal by the user. In this embodiment, the vertical member 18 has a length of approximately 42 inches to permit the decoy 12 to extend above the surface of water so that the decoy 12 mimics the landing behavior of a duck on the surface of water. The vertical member may be mated with one or more extension members (not shown) to add length (up to 10 feet) for deeper water placement or otherwise changing the appearance of the landing pattern by the decoy 12. The horizontal member 24 has a length of about 5 inches in this embodiment and is disposed a predetermined distance from the top 20 of the vertical member to serve to engage the stabilizer 16 by wrapping as shown in applicant's U.S. Patent Application Publication US 2017/0332620 entitled Decoy Technology, published Nov. 23, 2017, which is hereby incorporated by reference. The stabilizer 16 is preferably a bungee-type cord (preferably ⅛^{th} inch diameter) extending in a loop approximately 8 inches in length from the bottom of the decoy . In the preferred embodiment, the cord is orange color to simulate the color of the legs of a mallard duck. Other colors can be used depending upon the species and/or sex represented. Thus, the stabilizer 16 functions to hold the decoy 12 securely on the base 16 and also acts as part of the decoy simulation. Although the base 14 is preferably a stake type apparatus for mounting in earth, it is within the purview of the invention that the base could be constructed and arranged as a tri-pod or other configuration, provided that it has a T type top end with a male type top 20 connection for the decoy 12, a horizontal member for engaging the stabilizer 16.

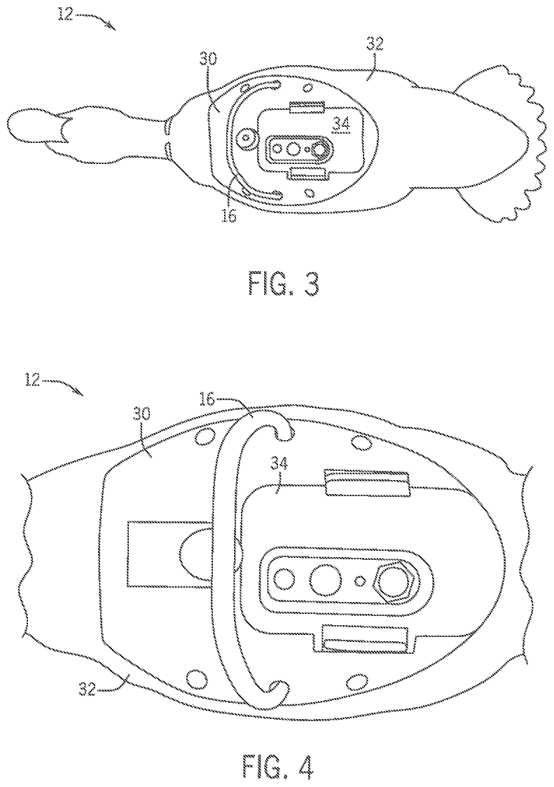

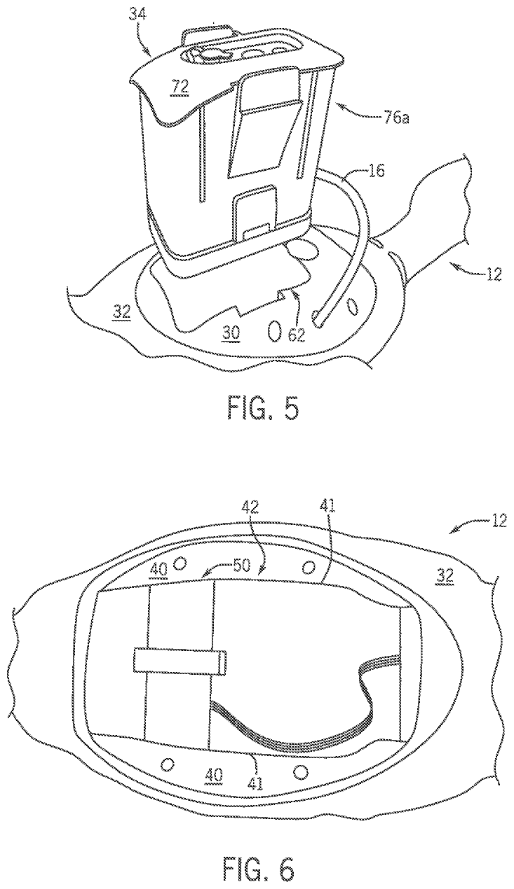

FIGS. 1-4 show the gross, exterior features of an embodiment of the waterproof decoy 12 of the present invention. FIGS. 3 and 4 show the bottom of the decoy 12, including a base member 30 fastened to a body 32 of the decoy 12, and a removable, waterproof, power and control module 34 inserted there into. FIG. 5 shows the module 34 being removed therefrom. FIG. 6 shows the body aperture 41, flange 40 and cavity 42 for connection of the base member 30 to the body 32. A water proof motor 50 is disposed in the body cavity 42.

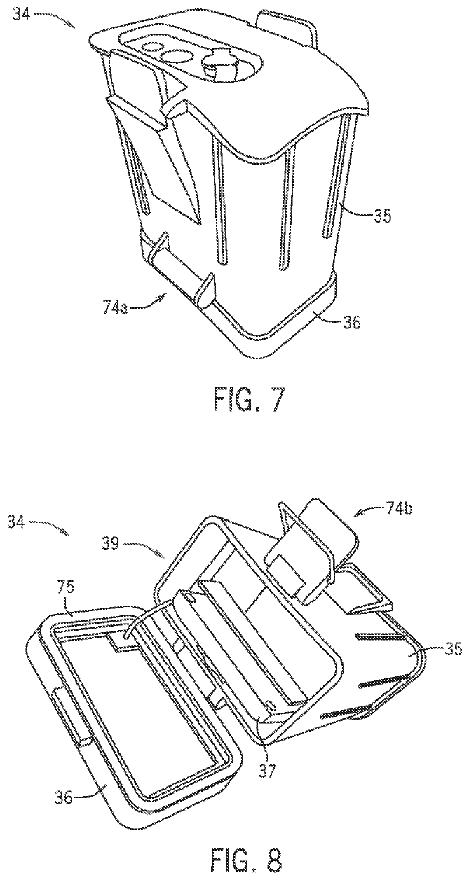

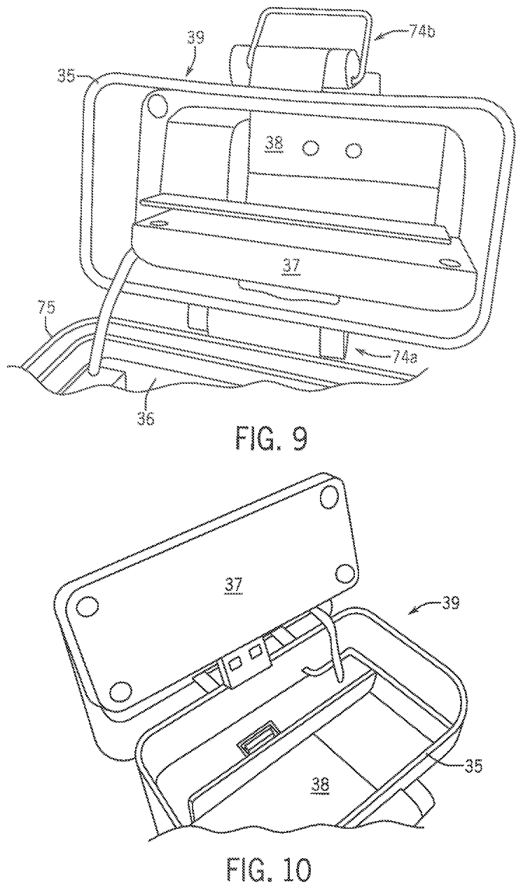

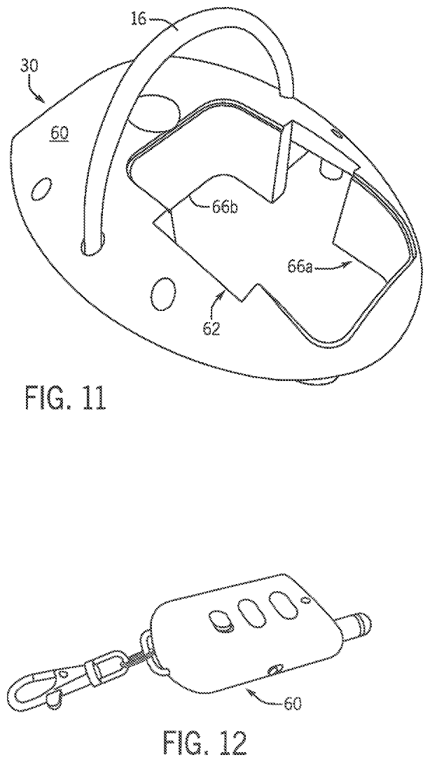

FIGS. 7-10 show exterior features of a preferred embodiment of the removable, water proof, control and power module 34. FIG. 8 shows the waterproof door 36 of the module 34 housing 35 in an open state, exposing the internal cavity 39, removable, software control card 37, and battery slot 38 thereof. FIG. 9 is a view of the open module 34. FIG. 10 shows an embodiment of the control card 37 being removed from the module 34. FIG. 11 shows external features of the base member 30 separated from the body 32 of the decoy 12. Details of the module 34 and base member 30 are discussed below. FIG. 12 shows an embodiment of a hand operable remote controller 60 for the decoy set 10.

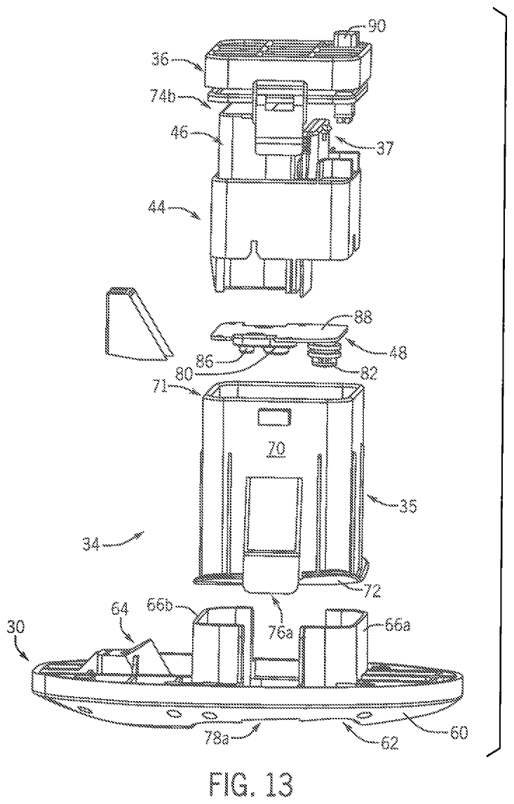

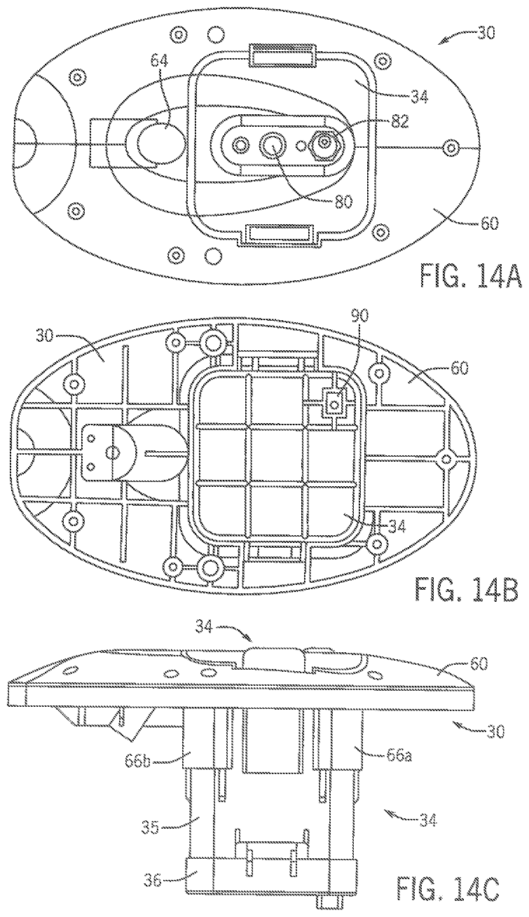

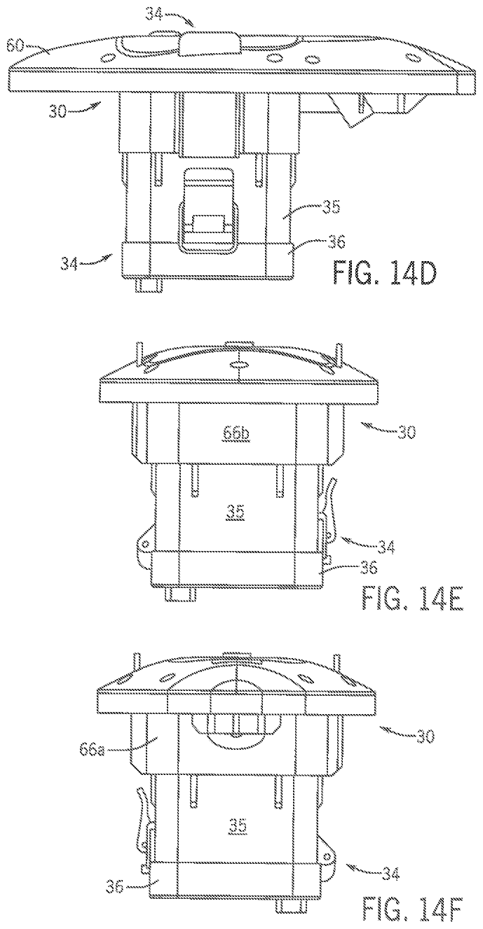

FIGS. 13 and 14 show the base member 30 and module 34 operatively joined but removed from the decoy body 32 for clarity. The joined assembly 30/34 includes the module housing 35, the module door 36 connected to the housing 35, a frame 44 disposed in the housing 35, a battery 46 held by the frame 44, and an electronic control circuit assembly 48 which is communicatively connected to the battery 46, software module 37 (if any), and the motor 50.

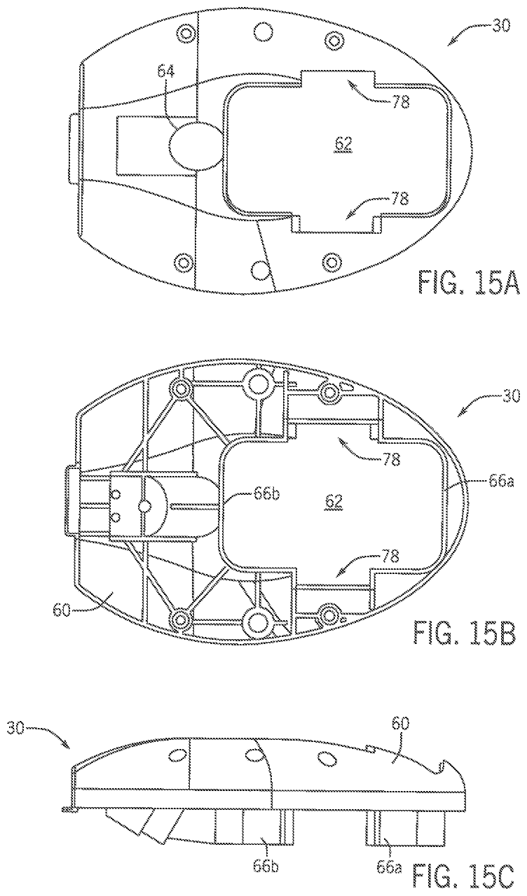

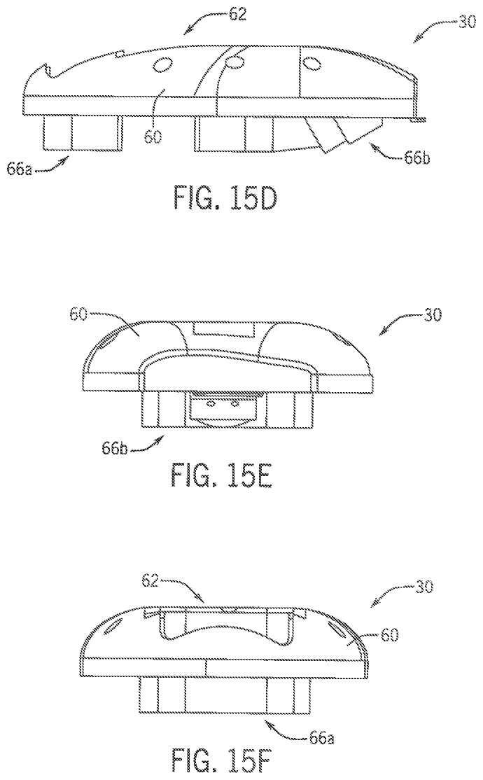

Referring also to FIGS. 15 a-f the base member 30 has an oval shell portion 60 with a module aperture 62 and a post aperture 64 disposed on its curved (convex) exterior facing side. A pair of brackets 66 a and b extend from the shell portion 60 on its frame worked, but overall substantially flat, interior facing side, aligned with the module aperture 62. The brackets 66 hold and stabilize the module 34 when operatively connected. The base member is preferably constructed of a polymeric material.

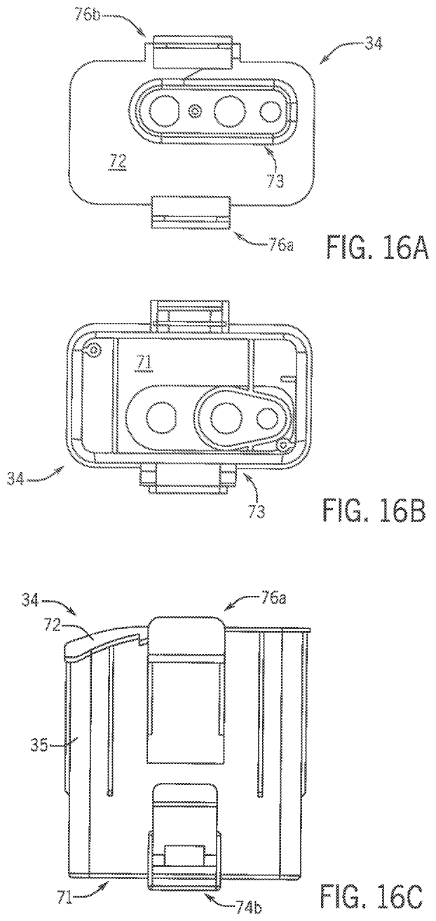

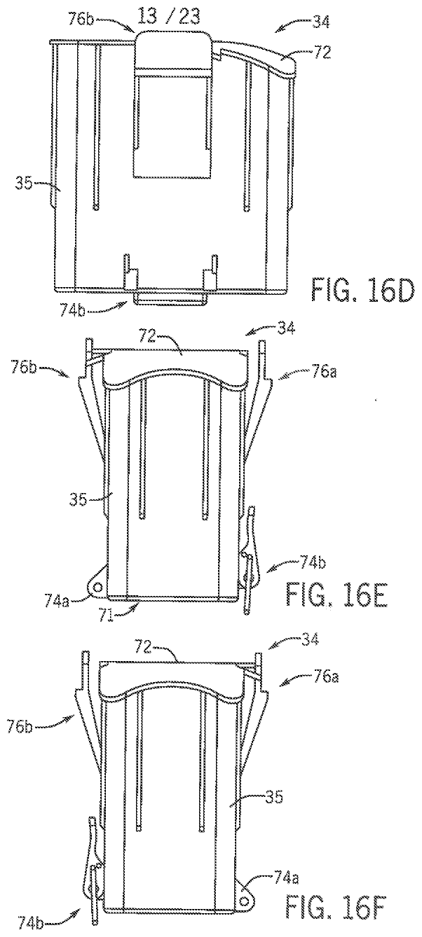

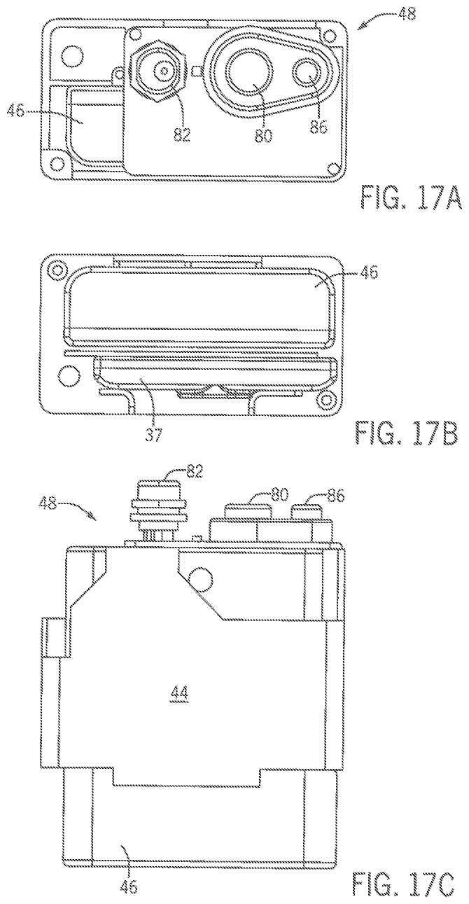

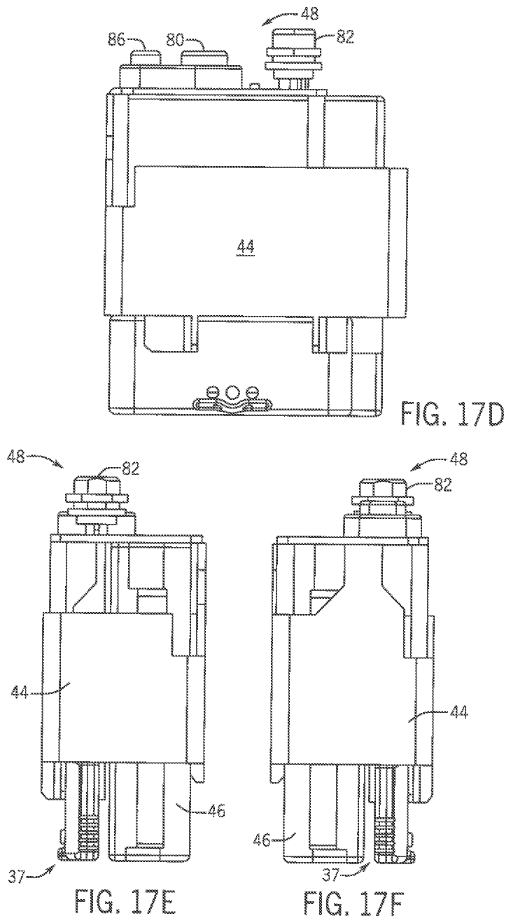

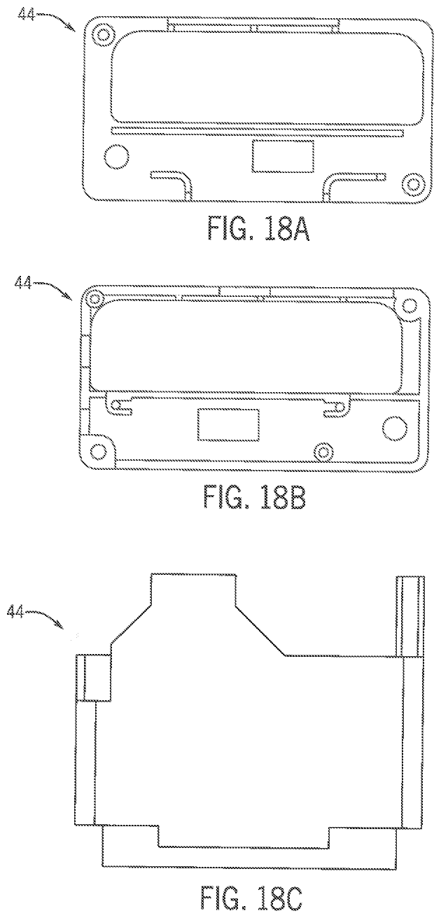

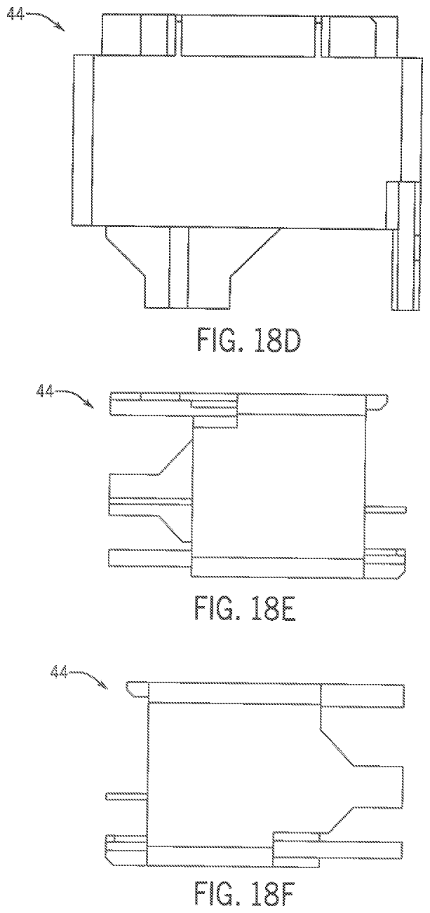

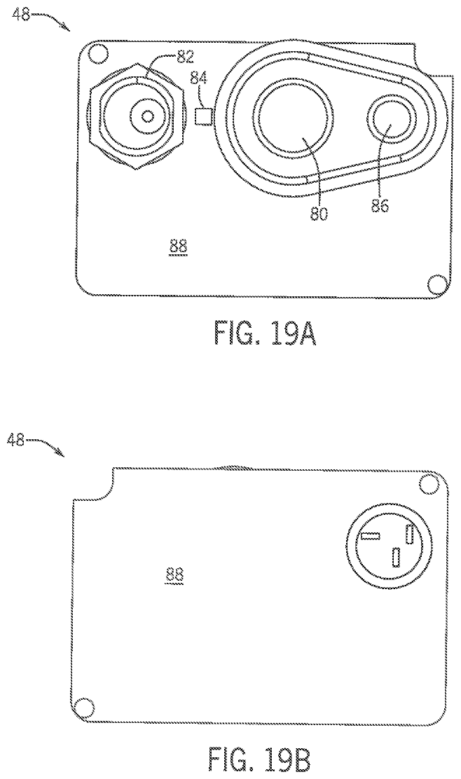

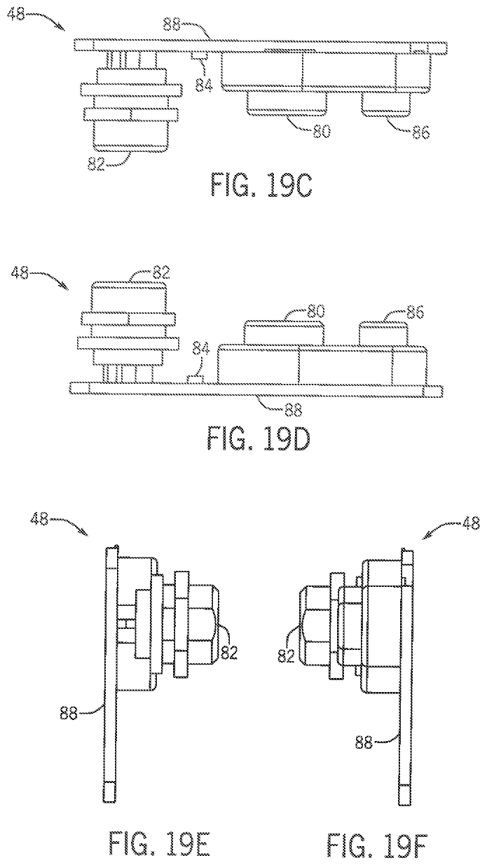

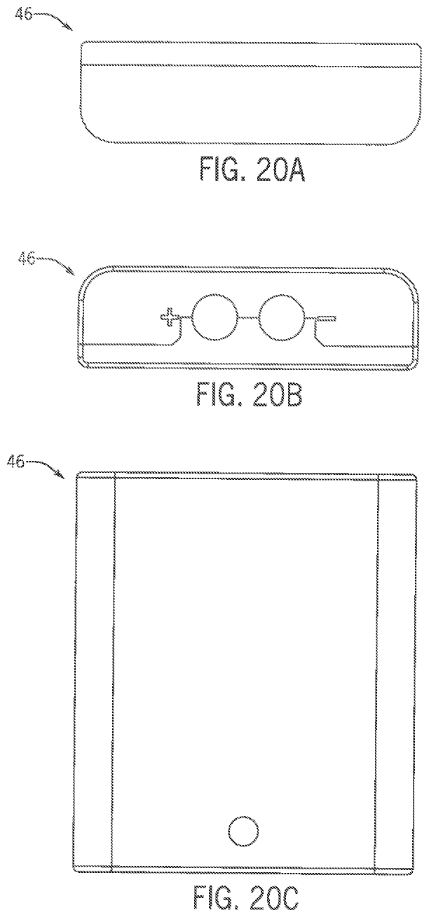

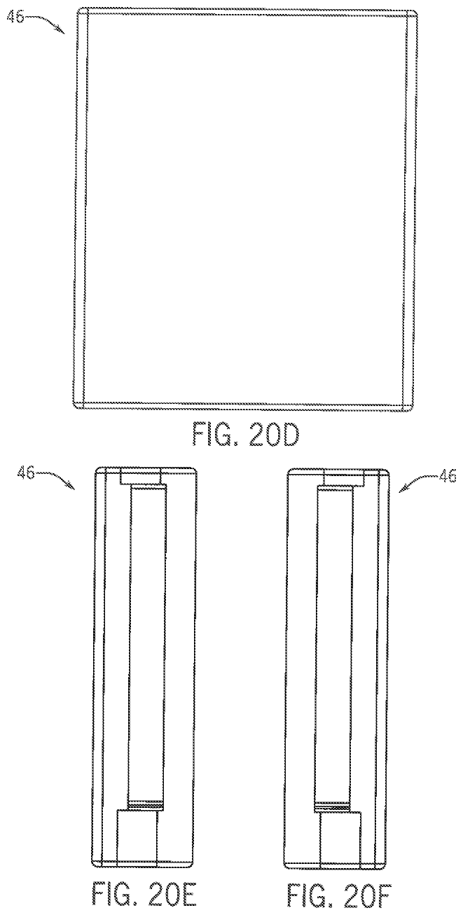

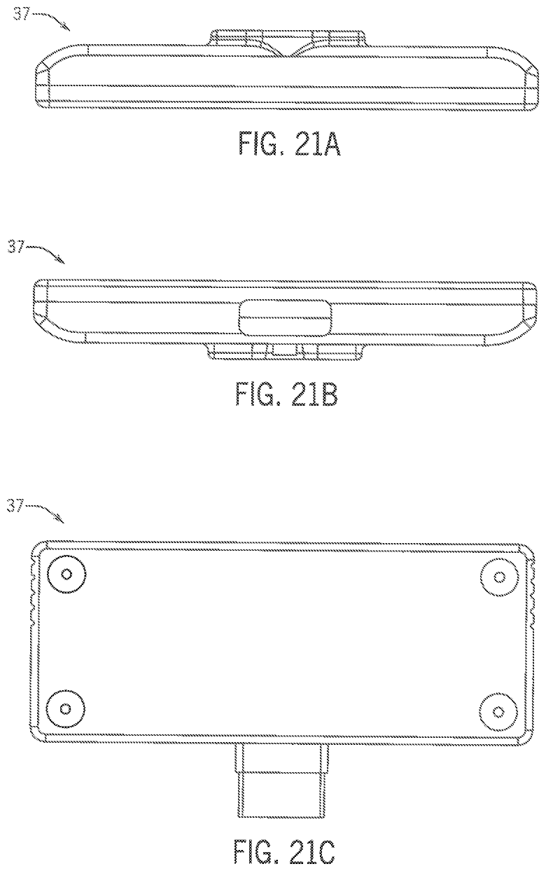

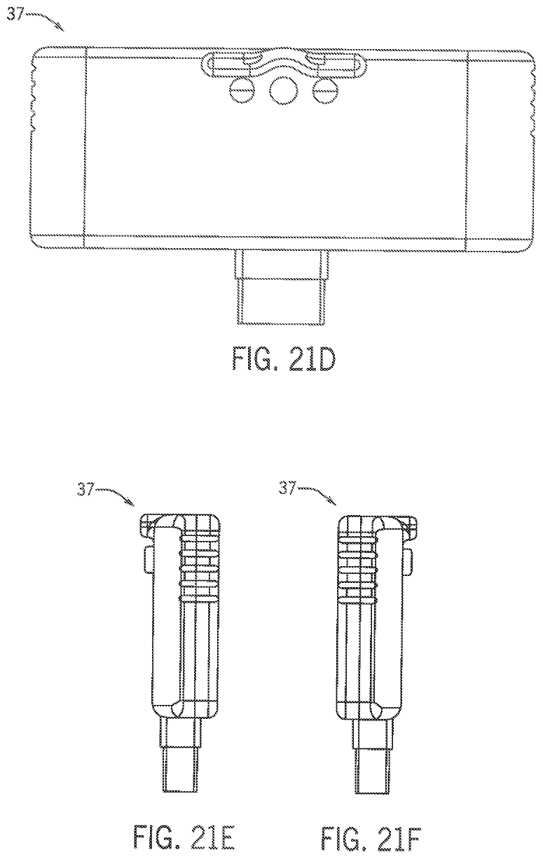

Referring also to FIGS. 16 a-f, the module 30 housing 35 has a rectangular shell 70 that is open to one end (top, interior) and forms a cavity 71 for holding the controller 48, the frame 44, the battery 46, and the software module 37. The door 36 is attached to the shell 70 via a hinge 74a and clasp 74b. Importantly, the door 36 has a watertight seal, preferably an O-ring, to seal the watertight cavity 71. The opposite end (bottom, exterior) of the shell 70 is sealed by an exterior wall 72 which is slightly curved to match with the exterior convex geometry of the shell 60 of the base 30. The wall 72 has sealed apertures 73 for watertight insertion of switches/connectors of the electronic control circuit 48 therethrough. The waterproof module 30 is conveniently and securely inserted into and pulled out of the aperture 62 of the base 30 in use to change batteries 46 or software 57, or for routine maintenance. The module 30 shell 70 has clasps 76 a and b disposed on opposing sides which couple with complementary connector portions 78 a and b disposed on the base 30.

Referring also to FIGS. 17 a-f and FIGS. 18 a-f, the module 34 frame 44 is coupled to the interior of the shell 70 to securely hold the battery 46 and the software module 37. The frame 44 aligns the battery 40 and software module to facilitate insertion and removal thereof. The control circuit 48 comprises an on/off switch (preferably button type) 80, a charging port 82, a battery status indicator 84, a synch to remote controller switch 86, and interconnected power and control circuit elements constructed on a PCB 88. The PCB 88 has connectors for the battery 46. the software module 37 and for connection to a waterproof sealed motor power plug 90 disposed in the door 36. The structure and arrangement of the battery 48 and software module 37 are further illustrated in FIGS. 20 a-f and FIGS. 21 a-f.

FIG. 25 shows the motor 50 mounted in the interior of the decoy 12. FIG. 26 is detailed view of an embodiment of the motor 50. FIG. 27 is a detailed view of one of the two motor to wing, spinning connections 54 a and b, from the exterior of the decoy body, and including an O-ring based, water tight seal.

The embodiments above are chosen, described and illustrated so that persons skilled in the art will he able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

1. A waterproof decoy comprising,
a decoy body constructed of a polymeric material, the decoy body having a top, a bottom and sides;
at least one decoy wing connected to the decoy body at one or more sides of the decoy body;
a power and control module, the power and control module being connectible and dis-connectible to the decoy body at the bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity.

2. The decoy of claim 1, wherein the decoy body is constructed of a polymeric material.

3. The decoy of claim 1, wherein the decoy body is shaped to simulate a waterfowl or migratory bird.

4. The decoy of claim 1 wherein the power and control module further includes a plug and play, USB connectible and disconnectible software module, disposed within the housing cavity.

5. The decoy of claim 4, wherein the plug and play software module provides remote control capability.

6. The decoy of claim 1, comprising two decoy wings, each decoy wing being a powered, moving wing and includes a shaft for mating with the decoy body and a wing panel connected to the shaft at the end opposite the mating connection.

7. The decoy of claim 1 wherein the decoy wing is connectible to the decoy body via a magnetic connection between the shaft and the decoy body.

8. The decoy of claim 1, wherein the decoy further comprises a motor assembly disposed in an interior cavity of the decoy body, the motor being communicatively connected to the power and control module and couplable to the at least one decoy wing.

9. The decoy of claim 8, wherein the motor assembly includes a motor connected to a motor mounting assembly, the motor being communicatively connected to the power and control module, and the motor mounting assembly being connected to the interior cavity of the decoy body.

10. The decoy of claim 1, wherein the power and control module further comprises a base member connected to the decoy body at the bottom of the decoy body, the waterproof housing being manually and readily connectible and dis-connectible from the base member without the use of tools.

11. The decoy of claim 1, wherein the electronic control assembly comprises an on/off switch communicatively connected to an electronic control circuit, a battery recharge port communicatively connected to the electronic control circuit, and a plug and play software module, connectible and dis-connectible from the control circuit, which provides remote control capability

12. The decoy of claim 1, further comprising:
a motor assembly disposed in an interior cavity of the decoy body, the motor assembly being communicatively connected to the power and control module and couplable to the at least one decoy wing;
wherein the power and control module further comprises a base member connected to the decoy body at the bottom of the decoy body, the waterproof housing being manually and readily connectible and dis-connectible from the base member without the use of tools; and
wherein the electronic control assembly comprises an on/off switch communicatively connected to an electronic control circuit, a battery recharge port communicatively connected to the electronic control circuit, and a plug and play software module, connectible and dis-connectible from the control circuit, which provides remote control capability.

13. The decoy of claim 12, wherein the door has a O-ring seal.

14. The decoy of claim 12, wherein the door has a waterproof seal power connector communicatively connecting the electronic control circuit and the motor.

15. The decoy of claim 12, wherein the base member a shell member connected to the decoy body, the shell member having an aperture through which the power and control module is insertable and removable.

16. The decoy of claim 15, wherein the power and control module housing has at least one base connector and the base member housing has at least one complementary module connector for readily connecting and disconnecting the power and control module to and from the base member, via the aperture in the shell member.

17. The decoy of claim 16, wherein the shell member has at least one bracket for guiding and stabilizing the power and control module.

18. The decoy of claim 12, wherein the power and control module has a frame member disposed inside the waterproof housing for stabilizing the battery therein.

19. A waterproof decoy comprising,
A a decoy body constructed of a polymeric material, the decoy body having a top, a bottom and sides;
B at least one decoy wing connected to the decoy body at one or more sides of the decoy body;
C a motor assembly disposed in an interior cavity of the decoy body, the motor assembly being communicatively connected to the power and control module and couplable to the at least one decoy wing;
D a base member connected to the decoy body at the bottom of the decoy body, the waterproof housing being manually and readily connectible and dis-connectible from the base member without the use of tools; and
E a power and control module, the power and control module being connectible and dis-connectible to the decoy body at the bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity, wherein:
i the electronic control assembly comprises an on/off switch communicatively connected to an electronic control circuit, a battery recharge port communicatively connected to the electronic control circuit, and a plug and play software module, connectible and dis-connectible from the control circuit, which provides remote control capability;
ii the base member a shell member connected to the decoy body, the shell member having an aperture through which the power and control module is insertable and removable; and
iii power and control module housing has at least one base connector and the base member housing has at least one complementary module connector for readily connecting and disconnecting the power and control module to and from the base member, via the aperture in the shell member.

20. A waterfowl or migratory bird decoy set comprising,
a waterproof, powered wing decoy;
a decoy base post adapted to be placed on an environmental surface, the decoy base adapted to hold the decoy in a predetermined position, the decoy being connectible and disconnectible from the decoy base, the decoy base including a vertical member, a male type connector disposed at the top of the decoy base, and a horizontal member connected to the vertical member a predetermined distance from the top of the vertical member thereby forming a T-shaped handle;
the waterproof decoy including,
A a decoy body constructed of a polymeric material, the decoy body having a top, a bottom and sides;
B at least one decoy wing connected to the decoy body at one or more sides of the decoy body;
C a motor assembly disposed in an interior cavity of the decoy body, the motor assembly being communicatively connected to the power and control module and couplable to the at least one decoy wing;
D a base member connected to the decoy body at the bottom of the decoy body, the waterproof housing being manually and readily connectible and dis-connectible from the base member without the use of tools; and
E a power and control module, the power and control module being connectible and dis-connectible to the decoy body at the bottom of the decoy body, the power and control module actuating the at least one decoy wing, the power and control module including a waterproof housing having a door enclosing a cavity, a battery disposed within the housing cavity, and an electronic control assembly communicatively connected to the battery and disposed within the housing cavity, wherein;
i the electronic control assembly comprises an on/off switch communicatively connected to an electronic control circuit, a battery recharge port communicatively connected to the electronic control circuit, and a plug and play software module, connectible and dis-connectible from the control circuit, which provides remote control capability;
ii the base member a shell member connected to the decoy body, the shell member having an aperture through which the power and control module is insertable and removable; and
iii power and control module housing has at least one base connector and the base member housing has at least one complementary module connector for readily connecting and disconnecting the power and control module to and from the base member, via the aperture in the shell member.
